(19) United States
(12) Patent Application Publication
(10) Pub. No.: US 2009/0191405 A1
(43) Pub. Date: Jul. 30, 2009

(54) METAL COATED WITH CERAMIC AND METHOD OF MANUFACTURING THE SAME

(75) Inventors: Joung II Kim, Pyeongtaek (KR); Chang Hyun Woo, Cheongju (KR); Jong Sung Yoon, Suwon (KR); Bae Seok Kim, Yongin (KR)

Correspondence Address: LEYDIG VOIT & MAYER, LTD, 700 THIRTEENTH ST. NW, SUITE 300, WASHINGTON, DC, 20005-3960, US

(73) Assignee: TOKAI CARBON KOREA CO., LTD., Anseong-si (KR)

(21) Appl. No.: 12/057,453

(22) Filed: Mar. 28, 2008

(30) Foreign Application Priority Data
Jan. 29, 2008 (KR) 2008-0008876

(51) Int. Cl. B32B 17/06; B05D 3/10

(52) U.S. Cl. 428/336; 428/433; 427/327

(57) ABSTRACT

A metal coated with ceramic and a method manufacturing the same. The metal contains chromium. A buffer layer is disposed on the metal, and a silicon carbide (SiC) coating layer is disposed on the buffer layer. The buffer layer has a thermal expansion coefficient between those of the metal and the SiC coating layer. The method includes annealing a metal containing chromium to form a chromium oxide layer on the metal, dissolving polycarbosilane (PCS) in a solvent to form a PCS coating solution, coating the chromium oxide layer with the PCS solution, and annealing the to form an SiC coating.

### BACKGROUND OF THE INVENTION

1. Field of the Invention

The present invention relates to a metal coated with ceramic on its surface and a method of manufacturing the same, and more particularly, to a metal coated with ceramic on a surface of the metal containing chrome and a method of manufacturing the same.

2. Description of the Related Art

In general, silicon carbide (SiC) is a ceramic material having superior chemical-resistant, oxidation-resistant, heat-resistant and wear-resistant properties. According to the related art, there were attempts to coat metal with such SiC by a thermal spray coating method or a chemical vapor deposition (CVD) method so as to enhance the chemical-resistant, oxidation-resistant, heat-resistant and wear-resistant properties. However, in a case of the thermal spray coating, since pure SiC could not be coated, a mixture containing SiC was coated. In addition, SiC could not be coated on the metal having a low melting point because the CVD method requires a high temperature.

That is, the metal having a low melting point may be melted while SiC is deposited on a surface of the metal by a CVD method using a process temperature of 1100° C. or more.

In addition, a crack may occur on a coating layer or the coating layer may be delaminated due to a difference in thermal expansion coefficient between the metal and SiC even when SiC is deposited on the metal having a high melting point by the CVD method.

### SUMMARY OF THE INVENTION

The present invention is directed to a metal coated with ceramic on a surface of the metal and a method of manufacturing the same, which can coat the metal having a relatively low melting point with pure SiC and prevent delamination from occurring due to a difference in thermal expansion coefficient between the metal and SiC.

In one aspect, the invention is directed to a metal coated with ceramic on a surface thereof, which includes: a metal containing chrome; a buffer layer disposed on the metal; and a silicon carbide (SiC) coating layer disposed on the buffer layer, wherein the buffer layer has a thermal expansion coefficient between those of the metal and the SiC coating layer.

In another aspect, the invention is directed to a method of manufacturing a metal coated with ceramic on a surface thereof, which includes: annealing a metal containing chrome to form a chromium oxide layer on the metal; solving polycarbosilane (PCS) in a solvent to form a PCS coating solution; coating the PCS coating solution on the chromium oxide layer and drying the PCS coating solution; and annealing the dried PCS to be transformed into a silicon carbide (SiC) coating layer.

### BRIEF DESCRIPTION OF THE DRAWINGS

The above and other objects, features and advantages of the present invention will become more apparent to those of ordinary skill in the art by describing in detail exemplary embodiments thereof with reference to the attached drawings in which:

FIG. 1 is a flow chart illustrating a method of manufacturing a metal coated with ceramic on a surface of the metal according to an exemplary embodiment of the present invention;

FIG. 2 is a cross-sectional view illustrating a metal coated with ceramic on a surface of the metal according to an exemplary embodiment of the present invention;

FIG. 3 is a flow chart illustrating a method of manufacturing a metal coated with ceramic on a surface of the metal according to a first exemplary embodiment of the present invention; and

FIG. 4 is a flow chart illustrating a method of manufacturing a metal coated with ceramic on a surface of the metal according to a second exemplary embodiment of the present invention.

### DETAILED DESCRIPTION OF THE INVENTION

The present invention will now be described more fully hereinafter with reference to the accompanying drawings.

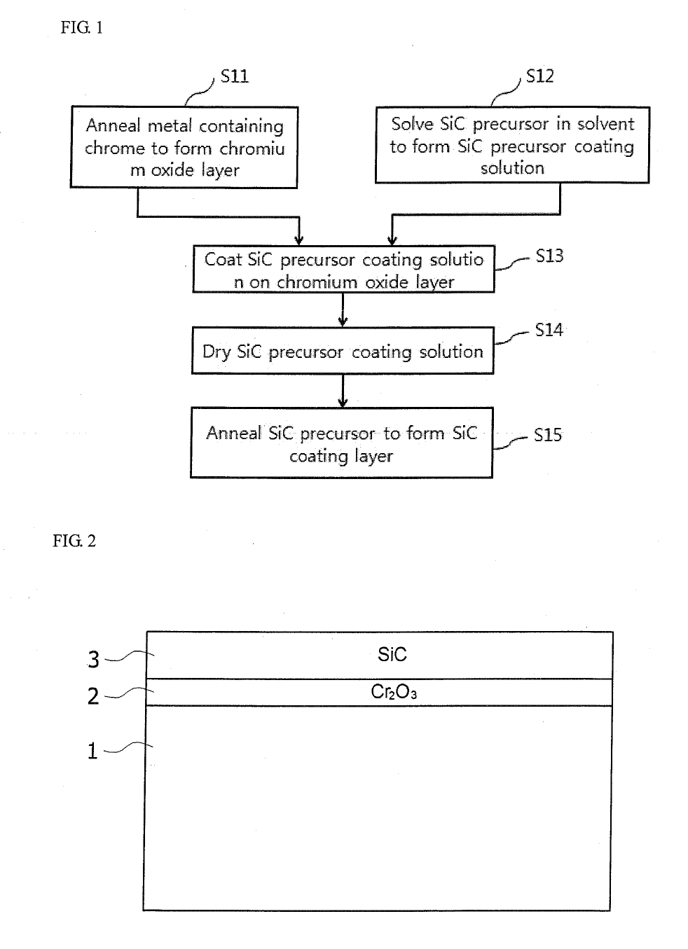

FIG. 1 is a flow chart illustrating a method of manufacturing a metal coated with ceramic on a surface of the metal according to an exemplary embodiment of the present invention.

Referring to FIG. 1, the method includes annealing a metal containing chrome to form a chromium oxide layer on the metal as a buffer layer (S11), manufacturing a SiC precursor coating solution (S12), coating the SiC precursor coating solution on the buffer layer (S13), drying the coated SiC precursor coating solution (S14), and transforming the coated SiC precursor into SiC by means of annealing (S15).

Hereinafter, the method of manufacturing the metal coated with ceramic on a surface of the metal according to an exemplary embodiment of the present invention will be described in more detail.

The metal containing chrome is first annealed to draw chrome on a surface of the metal, which then reacts with oxygen in the air to form chromium oxide (Cr₂O₃) as a buffer layer in step S11.

A SiC precursor material is solved in a solvent to obtain a coating solution in step S12.

At this time, polycarbosilane (PCS) may be used as the SiC precursor material, and hexane, xylan, toluene, or tetra-hydrofuron may be used as the solvent for solving the PCS.

The amount of PCS to be solved in the listed solvents may be adjusted to adjust the viscosity of the coating solution, and at this time, the viscosity of the coating solution is associated with the thickness of the SiC coating layer to be coated on the surface of the metal. That is, the thickness of the SiC coating layer may increase with the increasing viscosity of the solution.

The coating solution of which the PCS is solved in the solvent is then coated on the buffer layer in step S13.

At this time, the method of coating the coating solution may employ not only the annealing method but a dipping method of dipping metal with a buffer layer formed on its surface into the coating solution, a spin coating method of spinning the metal and dropping the coating solution onto the metal to make the coating solution spread to the uniform extent by means of the centrifugal force, a spray coating method of spraying the coating solution using a spraying device, and a flow coating method of flowing the coating solution on a substrate. The listed coating methods are merely respective examples, and other coating methods not listed above may be employed.

As such, the present invention, instead of employing a CVD method using heat of high temperature for directly coating SiC on the metal, coats the PCS as a SiC precursor material at a room temperature so that coating may be carried out regardless of the melting point of the metal, which is different from the related art.

The coating solution coated on the buffer layer is then dried in step S14.

The drying method may be carried out in an inert gas atmosphere or vacuum atmosphere. In addition, the drying method may be carried out in an air atmosphere for allowing PCS containing oxygen to be coated.

The solvent is dried by the drying method to form the PCS coating layer on a surface of the metal material.

The PCS coating layer is then annealed to remove a polymer component of the PCS so that the PCS coating layer is transformed into a SiC coating layer in step S15.

At this time, an increasing temperature rate must be adjusted in order to prevent bubbles from occurring on a surface of the SiC coating layer being transformed.

The most suitable increasing temperature rate ranges from 5° C./hr to 30° C./hr, and is preferred when the final temperature becomes about 700° C. to about 1500° C.

At this time, the final annealing temperature may be adjusted to obtain the SiC coating layer with a desired crystalline structure. That is, the annealing in a range of 1000° C. to 1500° C. allows the crystalline structure of the SiC coating layer to be crystalline, and the annealing in a range of 700° C. to 1000° C. allows the crystalline structure of the SiC coating layer to be amorphous.

In addition, the method may further include preprocessing the PCS coating layer to cure the PCS coating layer before carrying out step S15. This is for the purpose of enabling bonding between PCSs included in the PCS coating layer to be cross-linked to obtain a more fixed SiC coating layer and enhance yield and density.

The preprocessing may use ultraviolet light or electron beams of 5 to 20 MGy.

Besides, the PCS coating layer may be cured by means of oxidation at a temperature of 200° C. to 400° C.

FIG. 2 is a cross-sectional view of a metal coated with ceramic on a surface thereof manufactured by the method according to an exemplary embodiment of the present invention.

Referring to FIG. 2, the metal coated with ceramic includes a metal 1 containing chrome, a chromium oxide layer 2 disposed on the metal 1, and a SiC coating layer 3 coated on the chromium oxide layer 2.

A thermal expansion coefficient of the chromium oxide layer 2 lies in between those of the metal 1 and the SiC coating layer 3, which thus acts as a buffer to prevent the SiC coating layer 3 from being delaminated or cracked due to a difference in thermal expansion coefficient between the metal and the SiC coating layer so that the lifetime of the SiC coating layer may be lengthened.

Hereinafter, exemplary embodiments of the present invention will be described in detail.

### First Exemplary Embodiment

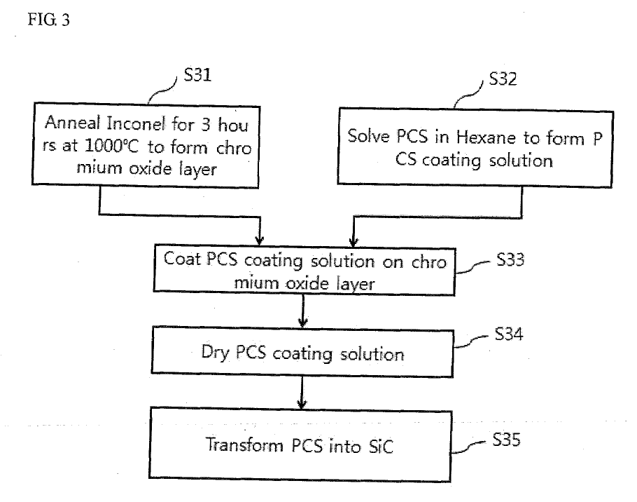

FIG. 3 is a flow chart illustrating a method of manufacturing a metal coated with ceramic on a surface of the metal according to a first exemplary embodiment of the present invention.

Referring to FIG. 3, according to the first exemplary embodiment, Inconel which is an alloy of nickel and chrome is first annealed to form a chromium oxide layer on the Inconel (S31).

At this time, the annealing is carried out for 2 to 3 hours at a temperature of 900° C. to 1100° C., and is preferably carried out for 3 hours at 1000° C.

Such annealing allows chrome which is more easily oxidized on the surface of the Inconel to be bonded with external oxygen to form a chromium oxide layer, and the thickness of the chromium oxide layer is in a range of 0.1 μm to 9 μm. At this time, the chromium oxide layer may not act as a buffer layer when the thickness of the chromium oxide layer is less than 0.1 μg, and a process time for forming the chromium oxide layer may be delayed when the thickness of the chromium oxide layer is greater than 9 μm, which is not economical.

The PCS is then solved in Hexane to form a PCS coating solution (S32).

The SiC precursor coating solution is coated on the chromium oxide layer by a dipping method (S33), and the coated PCS coating solution is dried to remove the Hexane (S34).

At this time, drying may be carried out in a nitrogen atmosphere to prevent oxidation from occurring.

The dried PCS is then annealed to be transformed into SiC (S35).

The annealing increases at a temperature increasing rate of 30° C./hr from a room temperature to 1000° C.

Although not shown in the drawings, the method may further include irradiating electron beams of 20 MGy onto the PCS to derive cross-linking between the PCSs and cure the PCS before carrying out the annealing of step S35.

Such a procedure as described above thus allows the Inconel, the chromium oxide layer disposed on the Inconel, and the SiC coating layer coated on the chromium oxide layer to be obtained.

### Second Exemplary Embodiment

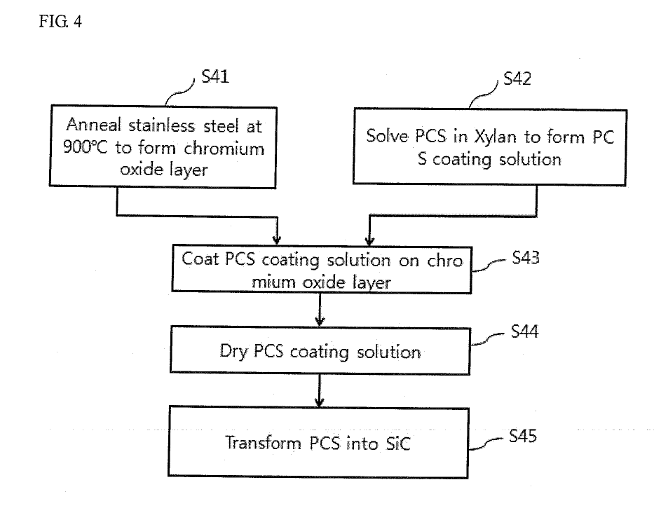

FIG. 4 is a flow chart illustrating a method of manufacturing a metal coated with ceramic on a surface of the metal according to a second exemplary embodiment of the present invention.

Referring to FIG. 4, according to the second exemplary embodiment, stainless steel (STS) which is an alloy of nickel and chrome is first annealed to form a chromium oxide layer on the STS (S41).

At this time, the annealing is carried out for 2 to 3 hours at a temperature of 700° C. to 900° C., and is preferably carried out for 3 hours at 900° C.

Such annealing allows chrome which is more easily oxidized on the surface of the STS to be bonded with external oxygen to form a chromium oxide layer, and the thickness of the chromium oxide layer is in a range of 0.1 μm to 9 μm.

The PCS is then solved in Xylan to form a PCS coating solution (S42).

The SiC precursor coating solution is coated on the chromium oxide layer by a dipping method (S43), and the coated PCS coating solution is dried to remove the Xylan (S44). At this time, drying is also carried out in an atmosphere excluding oxygen.

The dried PCS is then annealed to be transformed into SiC (S45).

The annealing increases at a temperature increasing rate of 20° C./hr from a room temperature to 800° C.

Although not shown in the drawings, the method may further include deriving cross-linking between the PCSs and curing the PCS by means of oxidation before carrying out the annealing of step S45.

Such a procedure as described above thus allows the STS having the chromium oxide layer as a buffer layer and the SiC coating layer coated on the chromium oxide layer to be obtained.

As such, the metal containing chrome may be annealed, the buffer layer having a thermal expansion coefficient between those of the metal and the ceramic may be formed on a surface of the metal, and the ceramic may be coated on the buffer layer, so that the ceramic may be prevented from being delaminated due to a difference in thermal expansion coefficient between the metal and the ceramic even when the metal is later exposed to heat.

According to the present invention as described above, a metal containing chrome is annealed, a chromium oxide layer as a buffer layer is formed, and SiC is coated on the buffer layer using a SiC precursor, so that ceramic can be coated without damaging the metal, and the buffer layer having a thermal expansion coefficient between those of the metal and the ceramic can be formed to prevent defects such as delamination from occurring.

While the invention has been particularly shown and described with reference to exemplary embodiments thereof, it will be understood by those of ordinary skill in the art that various changes in form and details may be made therein without departing from the spirit and scope of the present invention as defined by the following claims.

1. A metal coated with a ceramic, comprising:
a metal containing chromium;
a buffer layer disposed on the metal; and
a silicon carbide (SiC) coating disposed on the buffer layer, wherein the buffer layer has a thermal expansion coefficient between the thermal expansion coefficients of the metal and the SiC coating.

2. The metal coated with a ceramic according to claim 1, wherein the metal containing chromium is one of Inconel and stainless steel.

3. The metal coated with a ceramic according to claim 1, wherein the buffer layer is a chromium oxide layer and has a thickness in a range of 0.1 μm to 91 μm.

4. A method of manufacturing a metal coated with a ceramic comprising:
a) annealing a metal containing chromium to form a chromium oxide layer on the metal;
b) dissolving polycarbosilane (PCS) in a solvent to form a PCS coating solution;
c) coating the chromium oxide layer with the PCS coating solution and drying the PCS coating solution to leave a PCS coating; and
d) annealing and transforming the PCS coating into a silicon carbide (SiC) coating.

5. The method according to claim 4, wherein the metal containing chromium is one of Inconel and stainless steel.

6. The method according to claim 5, wherein the metal containing chromium is Inconel and including oxidizing the Inconel for 2 to 3 hours at a temperature of 900° C. to 1100° C., so that the chromium oxide layer has a thickness of 0.1 μm to 9 μm.

7. The method according to claim 5, wherein the metal containing chromium is stainless steel and including oxidizing the stainless steel for 2 to 3 hours at a temperature of 700° C. to 900° C., so that the chromium oxide layer has a thickness of 0.1 μm to 9 μm.

8. The method according to claim 4, further comprising preprocessing the PCS coating between the coating and annealing steps to cross-link the PCS coating.

9. The method according to claim 8, wherein the preprocessing includes at least one of irradiating the PCS coating with electron beams, irradiating the PCS coating with ultraviolet light, and oxidizing the PCS coating.

10. The metal coated with a ceramic according to claim 2, wherein the buffer layer is a chromium oxide layer and has a thickness in a range of 0.1 μm to 9 μm.
